(19) United States
(12) Patent Application Publication
(10) Pub. No.: US 2021/0016329 A1
(43) Pub. Date: Jan. 21, 2021

(54) Floor Maintenance and Tugging Machine

(71) Applicant: RPS Corporation, Racine, WI (US)

(72) Inventor: Sean K. Goff, Breckenridge, CO (US)

(21) Appl. No.: 16/923,847

(22) Filed: Jul. 8, 2020

Related U.S. Application Data
(60) Provisional application No. 62/876,294, filed on Jul. 19, 2019.

(51) Int. Cl. B08B 3/02; B64F 1/22

(52) U.S. Cl. CPC B08B 3/024; B08B 2203/0223; B08B 2203/0229; B64F 1/227

(57) ABSTRACT

A machine with a cleaning system and a tugging system. The cleaning system can include a floor cleaning feature configured to dispense a cleaning solution onto a floor surface, agitate the cleaning solution, and remove the cleaning solution from the floor surface. The cleaning system can include an onboard cleaning solution tank, an onboard recovery tank, and an onboard vacuum. The tugging system can include a hitch coupled to a front end of the machine and can be configured to tow an airplane.

### CROSS-REFERENCE TO RELATED APPLICATION

This application claims the benefit of U.S. provisional patent application No. 62/876,294 filed Jul. 19, 2019, which is hereby incorporated by reference for all purposes as if set forth in its entirety herein.

### STATEMENT OF FEDERALLY SPONSORED RESEARCH OR DEVELOPMENT

Not applicable.

### BACKGROUND

This invention relates to equipment for floor maintenance machines and, in particular, to floor maintenance machines that are configured to tow vehicles, such as airplanes.

Floor maintenance machines or scrubbers provide a way to clean dirty floor surfaces. Typically, an operator directs a floor maintenance machine over the surface to be cleaned by steering or guiding the floor maintenance machine. With the help of a supplied cleaning fluid, an oscillating pad or rotating brushes contained within a scrub deck of the floor maintenance machine can directly contact the floor surface to loosen debris on a surface of the floor. A variety of pads and suction devices on the floor maintenance machine can be used to then remove the loosened debris from the floor surface to clean the floor.

### SUMMARY OF THE INVENTION

Typically, such floor maintenance machines or scrubbers are single purpose. That is, they are configured only to clean surfaces and not perform any other substantial tasks.

Contemplated and disclosed herein are modifications to floor maintenance machines that permit the floor maintenance machines or scrubbers to perform an additional purpose as a tug for an aircraft.

Floor maintenance machines are not conventionally configured to tow an aircraft. In some environments, such as airplane hangars, a tow vehicle, or “tug,” is used to move an airplane in, out, and within the hangar. Tow vehicles are generally specialized vehicles with the sole purpose of towing or “tugging” an airplane and are not also configured to clean dirty floor surfaces.

To improve the efficiency and utility of equipment used in association with airplane hangar facilities, disclosed herein are improvements to floor cleaning machines with features directed to tugging airplanes. This multi-purpose machine incorporates functionality to clean airplane hangar floors and attach to an airplane to tow the airplane in, out, or within the airplane hangar, among other features related to cleaning and prepping airplanes.

Further, floor space in a hangar is typically at a premium and a multi-purpose machine reduces the amount of floor space required to store and maneuver the vehicles required to support operations in and around the hangar. Additionally, if a tug is already in service at the hangar, having a multi-purpose machine that can act as a backup to the tug is of great value.

According to one aspect, a machine is provided that can include a chassis, a floor cleaning feature coupled to the chassis, and a tugging system. The floor cleaning feature can be configured to dispense a cleaning solution onto a floor surface, agitate the cleaning solution, and remove the cleaning solution from the floor surface and a tugging system with a hitch. The tubbing system can have a hitch coupled to the chassis.

In some forms, the floor cleaning feature may include a vacuum to draw up the cleaning solution from the floor surface.

In other forms, the machine may include an onboard cleaning solution tank in which the cleaning solution is retained. The machine may also include a rinsing feature with a rinse hose in fluid communication with the onboard cleaning solution tank. The rinsing feature can include a nozzle.

In some forms, the machine may include an onboard recovery tank in which the cleaning solution removed from the floor surface is retained.

In other forms, the hitch of the tugging system may be a pintle hitch.

In some forms, the machine may include an onboard vacuum and a vacuum hose. The vacuum hose may be coupled to an onboard recovery tank.

In some forms, the machine may include an onboard antifreeze tank in fluid communication with an antifreeze hose and an antifreeze nozzle.

According to another aspect, a machine can be provided that includes a floor cleaning feature with a cleaning solution tank, a vacuum, and a recover tank. The machine can further include a tugging system configured to engage with an airplane. The tugging system can include a hitch mounted to the machine.

In some forms, the hitch of the tugging system may be a pintle hitch.

In other forms, the machine may include a chassis with a front end and a front steerable wheel proximal the front end. The hitch may be mounted to the front end and may extend forwardly beyond the front steerable wheel.

In some forms, the machine may include a rinsing feature with a rinse hose in fluid communication with the cleaning solution tank. The rinsing feature may include a nozzle.

In other forms, the machine may include a vacuum feature with a vacuum hose. The vacuum hose may be coupled of the vacuum and the onboard recovery tank.

In some forms, the machine may include an antifreeze feature including an onboard antifreeze tank in fluid communication with an antifreeze hose and an antifreeze nozzle.

These and still other advantages of the invention will be apparent from the detailed description and drawings. What follows is merely a description of some preferred embodiments of the present invention. To assess the full scope of the invention, the claims should be looked to as these preferred embodiments are not intended to be the only embodiments within the scope of the claims.

### BRIEF DESCRIPTION OF THE DRAWINGS

FIG. 1 is a perspective view a machine engaging a tugging functionality on an airplane.

FIG. 2 is side elevation view of the machine engaging the tugging functionality on an airplane.

FIG. 3 is a perspective view of the machine engaging a cleaning functionality on an airplane in the form of a sprayer.

FIG. 4 is a perspective view of the machine engaging another cleaning functionality on an airplane in form of a vacuum.

### DETAILED DESCRIPTION OF THE PREFERRED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some of the discussion below describes a machine that can be used to clean floors and tow a vehicle. The context and particulars of this discussion are presented as examples only. For example, embodiments of the disclosed invention can be configured in various ways, including with other shapes and arrangements of elements. Similarly, embodiments of the invention can be used with arrangements of cleaning and tow equipment other than those expressly illustrated or described herein.

In conventional arrangements of floor cleaning machines and towing machines, these machines are respectively employed to accomplish two distinct tasks, namely, clean floors and tow airplanes. Each machine is specially designed to accomplish its designated task, either cleaning floors or towing an airplane or aircraft. For purposes of aiding the general understanding of the reader about the construction and the nature of a floor cleaning machine, the reader can refer to U.S. Pat. No. 8,505,156 filed on Sep. 21, 2007; U.S. Pat. No. 9,980,556 filed on May 14, 2015; and U.S. Pat. Pub. No. 2016/0331201 filed May 5, 2016, which are incorporated herein by reference in their entirety for all purposes. Although each machine can accomplish its respective task individually, having two separate machines to do so increases initial investment costs, maintenance costs, and labor costs.

The embodiments disclosed herein in which a scrubber and a tug are combined into a single machine can address these or other issues. For example, in some embodiments, a machine can provide functionality for cleaning the floor and towing an airplane. Additionally, or alternatively, another example of a machine according to the invention can provide functionality directed to spraying flight control surfaces with antifreeze product, vacuuming interior plane carpets, and/or washing the plane. In some embodiments, no steps need to be taken to modify the machine when switching from functionality related to cleaning to functionality related to towing and vice versa.

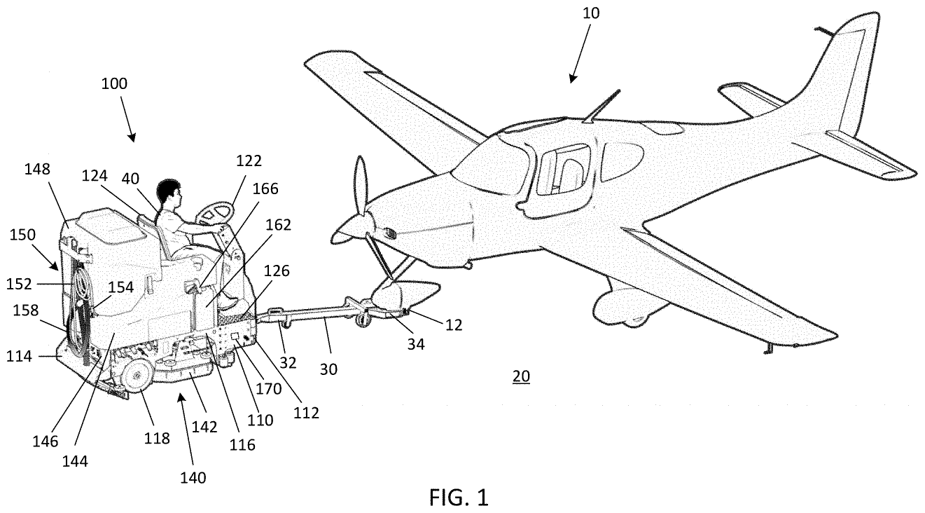

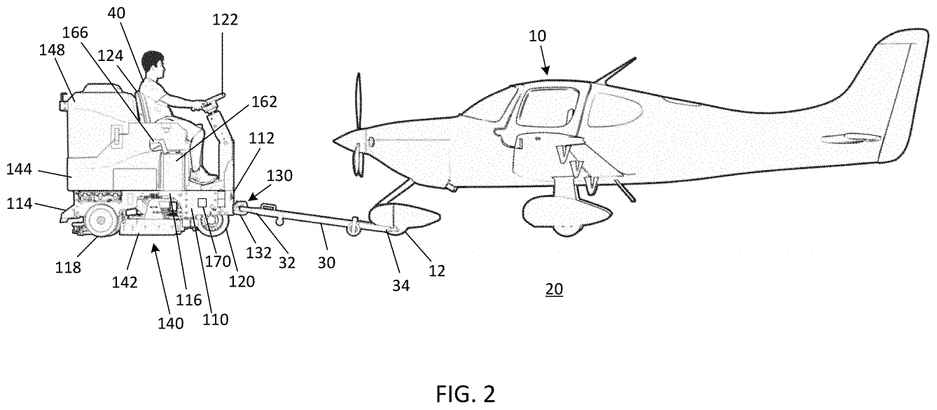

Referring first to FIGS. 1 and 2, a machine 100 is illustrated engaged in a tugging relationship with an airplane 10. The machine 100 includes a chassis 110, a tugging system 130 (marked in FIG. 2), and a cleaning system 140.

The chassis 110 has a front end 112 and a rear end 114 joined by sides 116. The chassis 110 is supported by floor engaging rear wheels 118 and a front steerable wheel 120. The front steerable wheel 120 is operatively connected to a steering wheel 122 through the chassis 110 proximal the chassis front end 112.

The chassis 110 houses a plurality of batteries that provide electrical power to an electric drive motor coupled to the front steerable wheel 120. The batteries also provide electrical power to other electrical components for controlling and operating the machine 100. The drive motor rotatably drives the front steerable wheel 120 and/or rear wheels 118 to propel the machine 100 along a floor 20. Although an electric motor powered by the batteries for rotatably driving one or more of the floor engaging rear wheels 118 or the front steerable wheel 120 is illustrated in the shown embodiment, any of the wheels 118, 120 can be driven by other means, such as, for example, an internal combustion engine powered by gasoline, natural gas, and the like. Of course, the usage environment may make some energy sources more preferable than others (i.e., a combustion engine that emits gases may not be suitable for indoor use without adequate ventilation).

A driver seat 124 is supported by the chassis 110 rearward of the steering wheel 122 for use by an operator operating the machine 100. The operator sits on the driver seat 124 to operate the steering wheel 122 and foot operated control pedals, such as a brake and accelerator supported above the chassis top surface 126.

The tugging system 130 as depicted in FIGS. 1 and 2 can include a pintle hitch 132. The pintle hitch 132 is shown extending forwardly from the front end 112 of the chassis 110 and beyond the front steerable wheel 120. The pintle hitch 132 could also extend rearwardly from the second end 114 of the chassis 110. The pintle hitch 132 is configured to receive one end 32 of a tow bar 30 with the other end 34 of the tow bar 30 engaging with the airplane 10, preferably at a front wheel 12 as shown here. Other types of hitching systems are contemplated, such as a ball hitch.

The cleaning system 140 as shown here includes a floor cleaning feature 142 configured to dispense a liquid cleaning solution from an onboard cleaning solution tank 144 onto the floor 20, agitate the cleaning solution on the floor 20 using brushes or other floor-cleaning or floor-engaging implements, and use suction (e.g., from an onboard vacuum 146) to draw the cleaning solution into an onboard recovery tank 148 which removes substantially all of the agitated cleaning solution from the surface of the floor 20 being cleaned by the machine 100.

The cleaning solution tank 144 and the recovery tank 148 are supported by the chassis 100 rearwardly of the driver seat 124 and proximal the rear end 114. The cleaning solution tank 144 and the recovery tank 148 can be formed from any material known in the art, such as plastic, metal, fiberglass, and the like without departing from the scope of the invention.

The cleaning system 140 can dispense the cleaning solution onto the floor 20 proximal the front end 112 of the chassis 110 as the machine 100 is driven on the floor 20. The cleaning solution can be gravity fed or pumped out of the cleaning solution tank 144. The cleaning solution can be dispensed onto the floor 20 through a spray bar, brushes, and/or nozzles.

The cleaning solution can be agitated by at least one retractable, rotating brush. Some embodiments can include a pair of retractable, cylindrical, counter rotating brushes disposed rearwardly of the mechanism dispensing the cleaning solution. The brushes can have parallel axes of rotation which are aligned transverse to the apparatus longitudinal centerline to provide a forward brush and a rearward brush. The counter rotating brushes are rotatably driven by an electrical motor, and agitate the cleaning solution on the floor 30 using radially extending bristles to dislodge dirt and grime adhering thereto.

Additionally, or alternatively, the cleaning system 140 can include a rinsing feature 150 as shown in FIG. 1. The rinsing feature 150 can include a rinse hose 152 and a nozzle 154. The rinsing feature 150 can also include a rinsing wand in some embodiments. The rinse hose 152 is in fluid communication with the cleaning solution tank 144 and a pump (not shown). In some embodiments, the cleaning solution tank 144 can be in fluid communication with a reservoir (not shown) housing a cleaning solution. The cleaning solution tank 144 can house water and can be fed with the cleaning solution from the reservoir by an onboard chemical blending mechanism to provide a mixture of water and cleaning solution at a predetermined mixture ratio. In some embodiments, water from a local water supply (not shown) can be used to fill the cleaning solution tank 144. It is contemplated that solely water from the cleaning solution tank 144 can be dispensed through the rinse hose 152. The water dispensed from the cleaning solution tank 144 can be used to wash the airplane 10. An operator 40 can maneuver the machine 100 adjacent to the area of the airplane 10 to be rinsed and can power on the pump and release pressurized cleaning solution (e.g., water or a mixture of water and cleaning solution) to clean the selected area of the airplane 10.

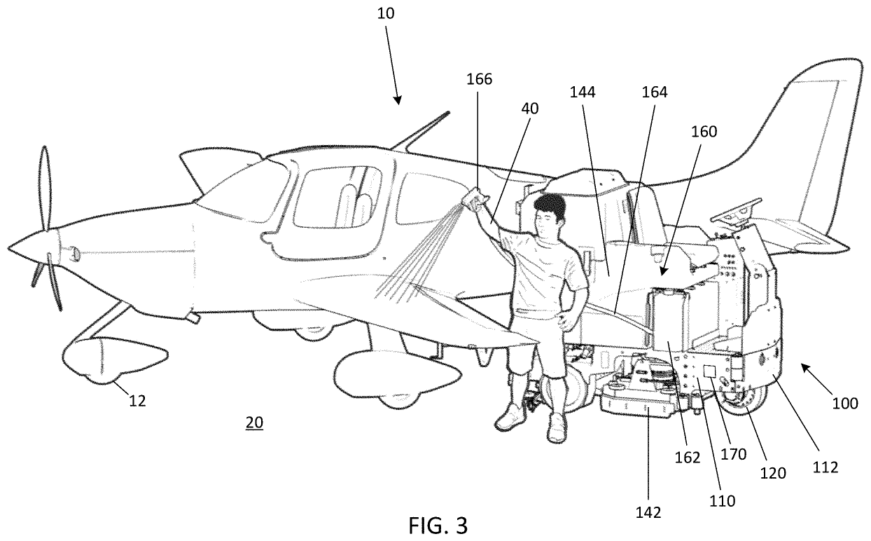

Additionally, or alternatively, an antifreeze feature 160 can be provided on the machine 100. Antifreeze product can be stored in onboard antifreeze tank 162 and dispensed through an antifreeze hose 164 and an antifreeze nozzle 166 in fluid communication with the antifreeze tank 162 and a pump (not shown). The antifreeze tank 162 is separate from the cleaning solution tank 144. In some embodiments the antifreeze tank 162 has a capacity of about one to three gallons. The antifreeze product stored in the antifreeze tank 162 can be, for example, TKS® 406B in-flight ice protection fluid offered for sale by CAV Systems Ltd. As shown in FIG. 3, an operator 40 can maneuver the machine 100 adjacent to the area of the airplane 10 to be treated and dispense antifreeze product to remove ice from the airplane 10 or as part of an ice-prevention measure.

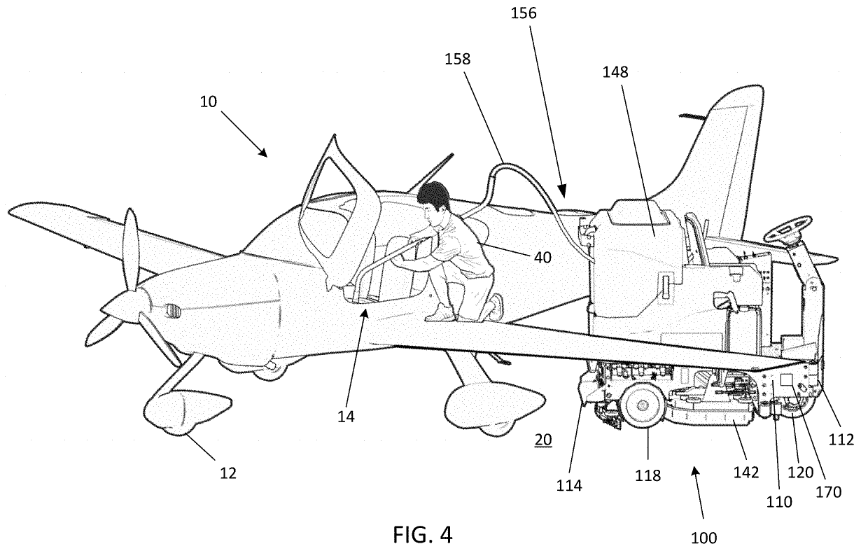

Additionally, or alternatively, the cleaning system 140 can include a vacuuming feature 156 as shown in FIG. 4. The vacuum feature 156 includes a vacuum hose 158 and can be in communication with the vacuum 146 on the machine 100. The operator 40 can maneuver the machine 100 adjacent to an opening 14 of the airplane 10 and can power on the vacuum 146 and, with the vacuum hose 158 extended into the airplane 10, can vacuum internal compartments of the airplane 10. Dirt and debris collected from the vacuum 146 can be deposited in the recovery tank 148 or a different onboard tank.

Additionally, or alternatively, other features may be included on the machine 100. For example, an air compressor 170 can be provided on the machine 100. The air compressor can be located inside or outside. In FIGS. 1-4 the air compressor 170 is shown mounted to the outside of the machine 100 on the chassis 110. The air compressor 170 can be used to check and alter the tire pressure of the tires (e.g. front tire 12) of the airplane 10. In some embodiments, lights (not shown) including but not limited to head lights and working lights located at the rear of the machine 100 can provided. The lights can enhance visibility and safe use of the machine 100. In some embodiments, a fire extinguisher (not shown) can be included on the machine 100. The fire extinguisher can similarly enhance overall safety of operation of the machine 100 in the event a fire event occurs within or around an airplane hangar.

In other embodiments, other configurations are possible. For example, certain features and combinations of features that are presented with respect to particular embodiments in the discussion above, can be utilized in other embodiments and in other combinations, as appropriate. In this regard, for example, different configurations of cleaning features (i.e. floor cleaning feature, rinsing feature, or vacuum feature) as presented with respect to the machine 100 can be implemented in different combinations in other embodiments.

Thus, embodiments of the inventions provide a machine capable of offering a number of cleaning features and also the ability to tow an airplane. In some embodiments, machines according to the invention can substantially reduce the time and labor that may be required in day-to-day activities in an airplane hangar, such as by obviating the need to have both a cleaning machine and a tow vehicle. Further, some embodiments of the invention can switch between functionalities (e.g., from floor cleaning to airplane tugging) without the need to make any adjustments or modifications to the machine.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A machine comprising:
a chassis;
a floor cleaning feature coupled to the chassis, the floor cleaning feature configured to dispense a cleaning solution onto a floor surface, agitate the cleaning solution, and remove the cleaning solution from the floor surface; and
a tugging system with a hitch in which the hitch coupled to the chassis.

2. The machine of claim 1, wherein the floor cleaning feature includes a vacuum to draw up the cleaning solution from the floor surface.

3. The machine of claim 1, further comprising an onboard cleaning solution tank in which the cleaning solution is retained.

4. The machine of claim 3, further comprising a rinsing feature including a rinse hose in fluid communication with the onboard cleaning solution tank.

5. The machine of claim 4, wherein the rinsing feature includes a nozzle.

6. The machine of claim 1, further comprising an onboard recovery tank in which the cleaning solution removed from the floor surface is retained.

7. The machine of claim 1, wherein the hitch is a pintle hitch.

8. The machine of claim 1, further comprising a vacuum feature including an onboard vacuum and a vacuum hose, the vacuum hose coupled to an onboard recovery tank.

9. The machine of claim 1, further comprising an antifreeze feature including an onboard antifreeze tank in fluid communication with an antifreeze hose and an antifreeze nozzle.

10. A machine including a floor cleaning feature with a cleaning solution tank, a vacuum, and a recovery tank, wherein the machine further comprises:
a tugging system configured to engage with an airplane, the tugging system including a hitch mounted to the machine.

11. The machine of claim 10, wherein the hitch is a pintle hitch.

12. The machine of claim 10, wherein the machine has a chassis with a front end and a front steerable wheel proximal the front end;
wherein the hitch is mounted to the front end and extends forwardly beyond the front steerable wheel.

13. The machine of claim 10, further comprising a rinsing feature including a rinse hose in fluid communication with the cleaning solution tank.

14. The machine of claim 13, wherein the rinsing feature includes a nozzle.

15. The machine of claim 10, further comprising a vacuum feature including a vacuum hose, the vacuum hose coupled to the vacuum and the onboard recovery tank.

16. The machine of claim 10, further comprising an antifreeze feature including an onboard antifreeze tank in fluid communication with an antifreeze hose and an antifreeze nozzle.
